(19) United States
(12) Patent Application Publication
(10) Pub. No.: US 2025/0343343 A1
(43) Pub. Date: Nov. 6, 2025

(54) NEGATIVE-REFRACTION IMPLEMENTATION METHOD USING PHOTO-MAGNON COUPLING AND CONTROL METHOD THEREFOR

(71) Applicant: SEOUL NATIONAL UNIVERSITY R&DB FOUNDATION, Seoul (KR)

(72) Inventors: Sang Koog KIM, Seongnam-si, Gyeonggi-do (KR); Bo Sung KIM, Yecheon-gun, Gyeongsangbuk-do (KR); Jun Young KIM, Seoul (KR); Bo Jong KIM, Seoul (KR)

(21) Appl. No.: 18/880,033

(22) PCT Filed: Jul. 5, 2023
(86) PCT No.: PCT/KR2023/009467

§ 371 Date: Dec. 30, 2024

(30) Foreign Application Priority Data
Jul. 13, 2022 (KR) 10-2022-0086023
Jun. 21, 2023 (KR) 10-2023-0079766

(51) Int. Cl. H01P 7/00; H01P 3/08

(52) U.S. Cl. CPC H01P 7/00; H01P 3/081

(57) ABSTRACT

Provided are a negative refraction implementation method using photon-magnon coupling and a control method therefor. The negative refraction implementation method of the present invention is a method of implementing negative refraction based on photon-magnon coupling using a photon-magnon hybrid system, wherein the photon-magnon hybrid system includes a dielectric layer including a first surface, and a second surface opposite to the first surface, a microstrip line disposed on the first surface and extending along a lengthwise direction, a first layer disposed on the second surface to excite a photon mode, and a second layer disposed on the microstrip line to excite a magnon mode, and wherein a negative refractive index signal is obtained due to photon-magnon coupling between the first and second layers.

### TECHNICAL FIELD

The present invention relates to a negative refraction implementation method using photon-magnon coupling and a control method therefor, and more particularly, to a negative refraction implementation method using coupling between a photon mode and a magnon mode, and a control method therefor.

### BACKGROUND ART

Metamaterials refer to composites artificially designed to implement properties that do not exist in nature. The characteristics of a metamaterial are determined based on the shape, geometric structure, size, direction, arrangement, etc. of basic structures forming the metamaterial. The metamaterials are most widely applied to the communication antenna and radar industries, and their application range is gradually expanding from ultra-high-speed communication technology, the Internet of Things, and wearable devices to sensors, lasers, solar energy generation, etc.

Negative refraction is a phenomenon where the refractive index of a material is less than 0, which does not occur in nature, and is one of the characteristics that only metamaterials may have. Electromagnetic waves traveling in a medium with a negative refractive index have a phase velocity and a group velocity in opposite directions, and thus a unique optical phenomenon that is not observed in existing positive refractive index media may occur. The negative refraction phenomenon may be applied to invisibility cloaks, super lenses, perfect absorbers, etc.

Existing metamaterials are produced by setting a target operating frequency and patterning an array of unit structures that each have resonant modes of permittivity and permeability at the frequency. The existing metamaterials have two major technical limitations. First, complex two-dimensional or three-dimensional patterning at the nano-micrometer level is required to produce a metamaterial, thereby causing difficulties in production. Second, because the operating frequency of a metamaterial is determined based on the size and shape of structures, the operating frequency and refractive index of the metamaterial is not controlled once it is made.

### DETAILED DESCRIPTION OF THE INVENTION

### Technical Problem

The present invention provides a method of implementing negative refraction by using photon-magnon coupling.

The present invention also provides a negative refraction implementation method using photon-magnon coupling and a control method therefor, by which a refractive index value and an operating frequency may be actively controlled.

The present invention also provides a negative refraction implementation method using photon-magnon coupling and a control method therefor, by which negative refraction may be more easily implemented than existing metamaterial production methods.

However, the above descriptions are examples, and the scope of the present invention is not limited thereto.

### Technical Solution

According to an aspect of the present invention, there is provided a method of implementing negative refraction based on photon-magnon coupling using a photon-magnon hybrid system, wherein the photon-magnon hybrid system includes a dielectric layer including a first surface, and a second surface opposite to the first surface, a microstrip line disposed on the first surface and extending along a lengthwise direction, a first layer disposed on the second surface to excite a photon mode, and a second layer disposed on the microstrip line to excite a magnon mode, and wherein a negative refractive index signal is obtained due to photon-magnon coupling between the first and second layers.

The first layer may include an inverted split-ring resonator (ISRR).

The first layer may serve as a ground plane.

The first layer may include an inductance part and a capacitance part, and have a resonance frequency.

The first layer may have a photon mode in which a resonance frequency is constant regardless of a strength of an external magnetic field.

The second layer may include yttrium iron garnet (YIG).

The second layer may have a magnon mode in which a resonance frequency increases when a strength of an external magnetic field increases.

When a permittivity and a magnetic permeability of the photon-magnon hybrid system are given as ε=ε′−i·ε″ and μ=μ′−i·μ″, respectively, ε′·μ″+ε″·μ′<0 may be satisfied.

The photon-magnon coupling may occur when resonance frequencies the first and second layers are matched by adjusting a strength of an applied magnetic field.

Due to the photon-magnon coupling, the photon and magnon modes may exhibit an anti-crossing phenomenon in an |S₂₁| or |S₁₂| spectrum corresponding to a resonance frequency region.

In the |S₂₁| spectrum, a negative refractive index signal may be exhibited at a high-frequency part in an anti-crossing region split into high-frequency and low-frequency parts.

In the |S₁₂| spectrum, a negative refractive index signal may be exhibited at a low-frequency part in an anti-crossing region split into high-frequency and low-frequency parts.

The |S₂₁| spectrum may exhibit evident mode splitting when the photon-magnon coupling is strong.

In the |S₂₁| spectrum, a real part n′ of a refractive index n may be changed to a negative value at a frequency at least higher than a resonance frequency of the first layer, in a anti-crossing region.

In the |S₁₂| spectrum, a real part n′ of a refractive index n may be changed to a negative value at a frequency at least lower than a resonance frequency of the first layer, in a anti-crossing region.

A frequency band where the negative refractive index signal is exhibited may be wider than 380 MHz.

At least one of a strength and a frequency of an applied magnetic field may be adjusted to satisfy ε′·μ″+ε″·μ′<0, and a negative refractive index may be switched on when ε′·μ″+ε″·μ′<0 is satisfied, or off when ε′·μ″+ε″·μ′<0 is not satisfied.

According to another aspect of the present invention, there is provided a method of implementing negative refraction based on photon-magnon coupling using a photon-magnon hybrid system, wherein the photon-magnon hybrid system includes a first part for exciting a photon mode, and a second part for exciting a magnon mode, and wherein a negative refractive index signal is obtained due to photon-magnon coupling between the first and second parts.

When a permittivity and a magnetic permeability of the photon-magnon hybrid system are given as ε=ε′−i·ε″ and μ=μ′−i·μ″, respectively, the negative refractive index signal may be obtained by adjusting at least one of a strength and a frequency of an applied magnetic field to satisfy ε′·μ″+ε″·μ′<0.

According to another aspect of the present invention, there is provided a method of controlling negative refraction based on photon-magnon coupling using a photon-magnon hybrid system, wherein the photon-magnon hybrid system includes a dielectric layer including a first surface, and a second surface opposite to the first surface, a microstrip line disposed on the first surface and extending along a lengthwise direction, a first layer disposed on the second surface to excite a photon mode, and a second layer disposed on the microstrip line to excite a magnon mode, wherein a negative refractive index signal is obtained due to photon-magnon coupling between the first and second layers, and wherein, when a permittivity and a magnetic permeability of the photon-magnon hybrid system are given as ε=ε′−i·ε″ and μ=μ′−i·μ″, respectively, at least one of a strength and a frequency of an applied magnetic field is adjusted to satisfy ε′·μ″+ε″·μ′<0.

### Advantageous Effects

As described above, according to an embodiment of the present invention, negative refraction may be implemented using photon-magnon coupling.

According to an embodiment of the present invention, a refractive index value and an operating frequency may be actively controlled.

According to an embodiment of the present invention, negative refraction may be more easily implemented than existing metamaterial production methods.

However, the scope of the present invention is not limited to the above effects.

### DESCRIPTION OF THE DRAWINGS

FIG. 1 is a schematic view of an inverted split-ring resonator (ISRR) sample patterned in a ground plane of a microstrip line for photon mode measurement.

FIG. 2 is a graph of frequency vs |S₂₁| showing a photon mode and external magnetic field dependence of an ISRR measured through a vector network analyzer (VNA).

FIG. 3 is an S₂₁ parameter absorption spectrum of external magnetic field vs frequency showing a photon mode and external magnetic field dependence of an ISRR measured through a VNA.

FIG. 4 is a graph showing the change in relative permittivity near a resonance frequency of an ISRR.

FIG. 5 is a schematic view of yttrium iron garnet (YIG) disposed on a microstrip line for magnon mode measurement.

FIG. 6 is a graph of frequency vs |S₂₁| showing a magnon mode and external magnetic field dependence of YIG measured through a VNA.

FIG. 7 is a graph of external magnetic field vs frequency showing a magnon mode and external magnetic field dependence of YIG measured through a VNA.

FIG. 8 is a schematic view of a photon-magnon coupling system according to an embodiment of the present invention.

FIG. 9 includes graphs showing (a) an S₂₁ parameter amplitude, (b) an S₂₁ parameter phase, (c) and (d) real and imaginary parts of a refractive index, (e) and (f) real and imaginary parts of an effective relative permittivity, and (g) and (h) real and imaginary parts of an effective relative permeability of ISRR/YIG coupling measured through a VNA, according to an embodiment of the present invention.

FIG. 10 includes graphs showing |Sᵢⱼ|, a retrieved refractive index, an effective relative permittivity, and an effective relative permeability of ISRR/YIG coupling measured through a VNA at (a) μ₀H=0, (b) μ₀H=61.4 mT, (c) a coupling center μ₀H=71.9 mT, and (d) μ₀H=84.1 mT, according to an embodiment of the present invention.

FIG. 11 includes graphs showing |Sᵢⱼ|, a retrieved refractive index, an effective relative permittivity, and an effective relative permeability of ISRR/YIG coupling measured through a VNA at a coupling center μ₀H=71.9 mT, according to an embodiment of the present invention.

FIG. 12 includes graphs showing (a) an S₁₂ parameter amplitude, (b) an S₁₂ parameter phase, (c) and (d) real and imaginary parts of a refractive index, (e) and (f) real and imaginary parts of an effective relative permittivity, and (g) and (h) real and imaginary parts of an effective relative permeability of ISRR/YIG coupling measured through a VNA, according to an embodiment of the present invention.

FIG. 13 is a schematic view showing various ISRR shapes according to embodiments of the present invention.

FIG. 14 is a schematic view showing various photon-magnon coupling system arrangements, according to embodiments of the present invention.

### MODE OF THE INVENTION

The following detailed description of the invention will be made with reference to the accompanying drawings illustrating specific embodiments of the invention by way of example. These embodiments will be described in sufficient detail such that the invention may be carried out by one of ordinary skill in the art. It should be understood that various embodiments of the invention are different but do not need to be mutually exclusive. For example, a specific shape, structure, or characteristic described herein in relation to an embodiment may be implemented as another embodiment without departing from the scope of the invention. In addition, it should be understood that positions or arrangements of individual elements in each disclosed embodiment may be changed without departing from the scope of the invention. Therefore, the following detailed description should not be construed as being restrictive and, if appropriately described, the scope of the invention is defined only by the appended claims and equivalents thereof. In the drawings, like reference numerals denote like functions, and lengths, areas, thicknesses, and shapes may be exaggerated for convenience's sake.

Hereinafter, the present invention will be described in detail by explaining embodiments of the invention with reference to the attached drawings, such that one of ordinary skill in the art may easily carry out the invention.

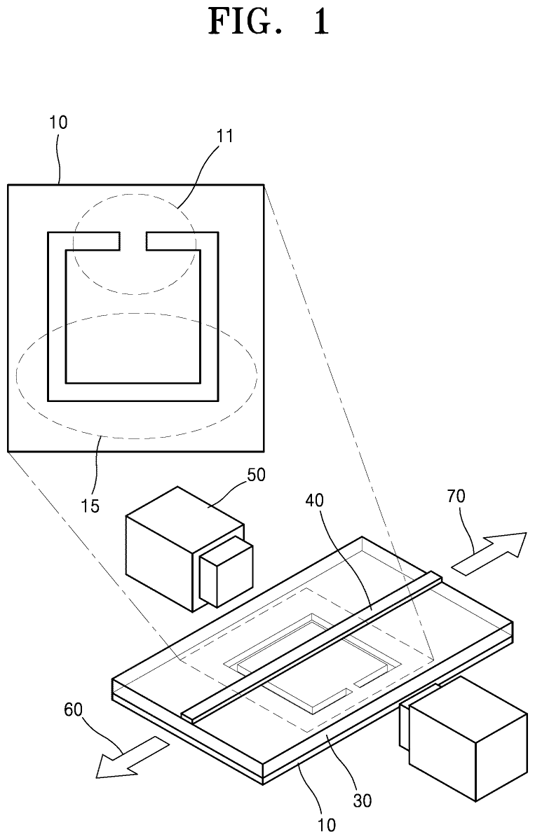

FIG. 1 is a schematic view of an inverted split-ring resonator (ISRR) sample patterned in a ground plane of a microstrip line for photon mode measurement.

Referring to FIG. 1, an ISRR 10 is prepared for photon mode measurement. The ISRR 10 has a form in which a split ring is patterned in a thin film. A discontinuous part 11 of the pattern serves as an inductance part, and a continuous part 15 of the pattern serves as a capacitance part.

A dielectric layer 30 is disposed on the ISRR layer 10. A microstrip line 40 is provided on the dielectric layer 30. The ISRR 10 may serve as a ground plane. In another point of view, the ISRR 10 may be positioned inside a ground plane. According to an embodiment, the ISRR 10 and the microstrip line 40 may be produced using photo-lithography.

To measure external static magnetic field dependence, a sample in which the ISRR 10, the dielectric layer 30, and the microstrip line 40 are laminated may be positioned between a pair of electromagnets 50. Both ends of the microstrip line 40 of the sample may be connected to a vector network analyzer (VNA) 60 and 70 for measurement.

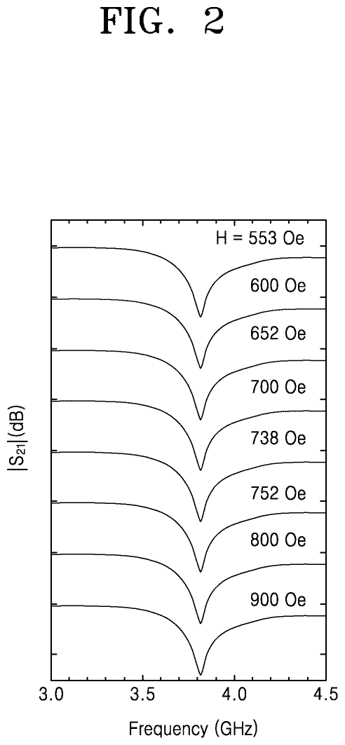

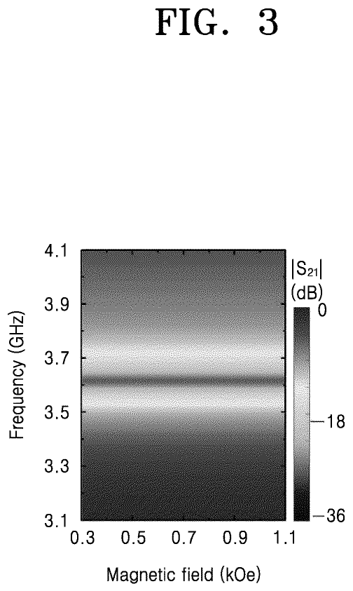

FIG. 2 is a graph of frequency vs |S₂₁| showing a photon mode and external magnetic field dependence of an ISRR measured through a VNA. FIG. 3 is an S₂₁ parameter absorption spectrum of external magnetic field vs frequency showing a photon mode and external magnetic field dependence of an ISRR measured through a VNA.

The ISRR 10 consists of an inductance L_{ISRR} and a capacitance C_{ISRR} and has its own resonance frequency [ω_{ISRR}²=(L_{ISRR}C_{ISRR})⁻¹]. This is called a photon mode. The resonance frequency may be changed depending on the size and shape of the ISRR 10.

An effective relative permittivity ε_{eff} is given as follows.

$${ε}_{eff} = {ε}_{eff}^{′} - i \cdot {ε}_{eff}^{″} = \frac{ε}{{ε}_{0}} = 1 - \frac{{ω}_{ep}^{2}}{{ω}^{2} - {ω}_{ISRR}^{2} + i ζω} \qquad ( Equation 1 )$$

(where ε₀ denotes a vacuum permittivity, ω denotes an angular frequency of an alternating current (AC) flowing through the microstrip line, ζ denotes a dissipation factor, and ωₑₚ denotes an electric plasma frequency.)

Referring to FIGS. 2 and 3, |S₂₁| represents a ratio between an input value and an output value, and it is shown that the resonance frequency has a constant value regardless of the strength of an external magnetic field. It is also shown that the photon mode has no external magnetic field dependence. Because the photon mode does not depend on the strength of an applied bias magnetic field μ₀H, ε_{eff} is independent of μ₀H and may only vary with ω.

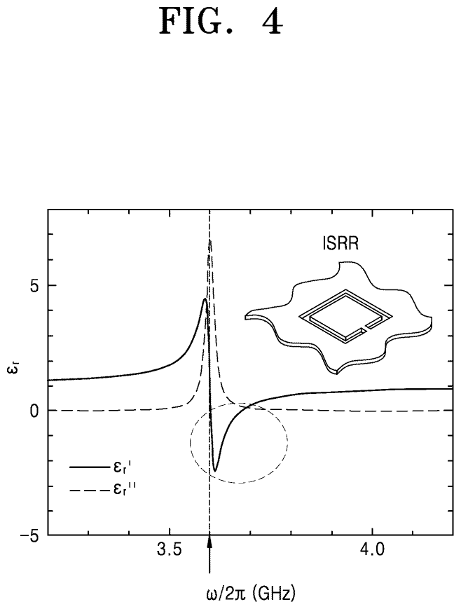

FIG. 4 is a graph showing the change in relative permittivity near a resonance frequency of an ISRR.

According to an embodiment, an effective relative permittivity is calculated using ωₑₚ/2ð=6.4 GHz, ω_{ISRR}/2ð=3.35 GHz, and ζ/2ð=3 MHz in Equation 1. The effective relative permittivity may be expressed as εr=εᵣ′−iεᵣ″ (where εᵣ′ is a real part and εᵣ″ is an imaginary part), and a negative relative permittivity (negative εᵣ′) is exhibited at the resonance frequency indicated by an arrow in FIG. 4 (see a dotted circle in FIG. 4).

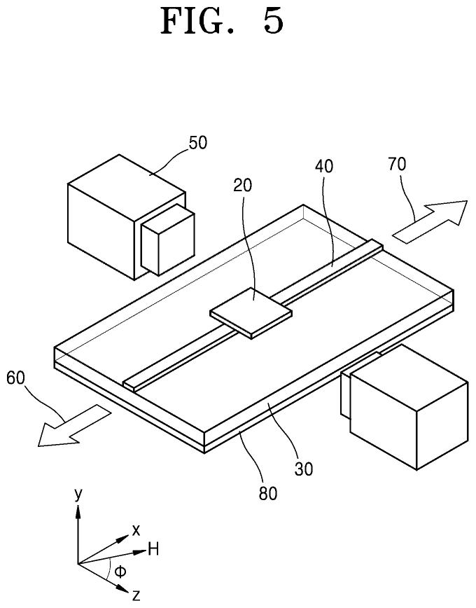

FIG. 5 is a schematic view of yttrium iron garnet (YIG) disposed on a microstrip line for magnon mode measurement.

Referring to FIG. 5, YIG 20 is prepared for magnon mode measurement. According to an embodiment, the YIG layer 20 may be deposited on a gadolinium gallium garnet (GGG) substrate through pulsed-laser deposition (PDL). Unlike in FIG. 1, the ISRR layer 10 is not provided and an unpatterned ground plane 80 may be used. The dielectric layer 30 is disposed on the ground plane 80, and the microstrip line 40 is provided on the dielectric layer 30. The YIG layer 20 may be disposed on the microstrip line 40.

To measure external static magnetic field dependence, a sample in which the ground plane 80, the dielectric layer 30, the microstrip line 40, and the YIG layer 20 are laminated may be positioned between a pair of electromagnets 50. Both ends of the microstrip line 40 of the sample may be connected to the VNA 60 and 70 for measurement.

An effective relative permeability μ_{eff-} for a simplified isotropic magnetic material is given as follows.

$${μ}_{eff} = {μ}_{eff}^{′} - i \cdot {μ}_{eff}^{″} = \frac{μ}{{μ}_{0}} = 1 + \frac{{ωω}_{m} ( {ω}_{H} + {ω}_{m} + i ωα )}{{ω}_{r}^{2} - {ω}^{2} + i ωα ( 2 {ω}_{H} + {ω}_{m} )} \qquad ( Equation 2 )$$

(where μ₀ denotes a vacuum permeability, ωₘ, ω_{H}, and ωᵣ denote effective characteristic and ferromagnetic resonance (FMR) frequencies of the given magnetic material, and α denotes an intrinsic Gilbert damping constant.)

At a gyromagnetic ratio γ₀/2π of the YIG layer 20, ωₘ=γ₀μ₀Mₛ, ω_{H}=γ₀μ₀H, and μ₀Mₛ are given as saturation magnetization.

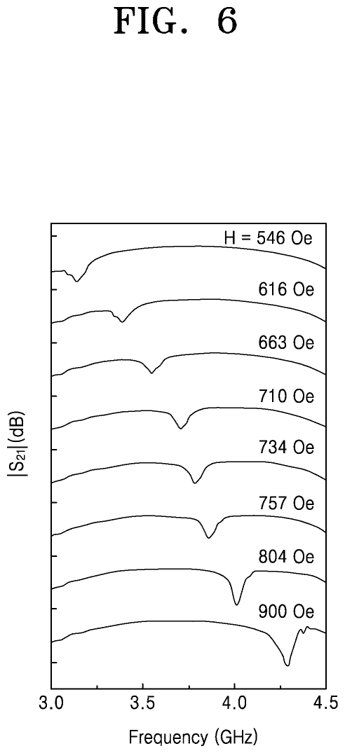

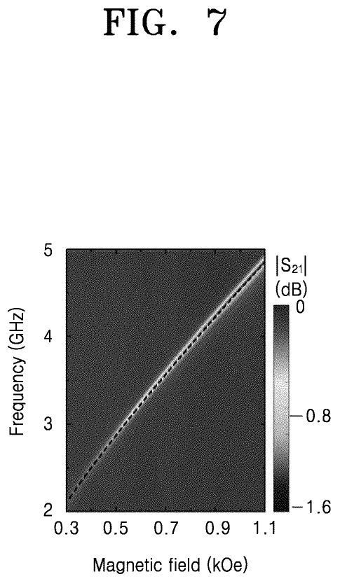

FIG. 6 is a graph of frequency vs |S₂₁| showing a magnon mode and external magnetic field dependence of YIG measured through a VNA. FIG. 7 is a graph of external magnetic field vs frequency showing a magnon mode and external magnetic field dependence of YIG measured through a VNA.

Referring to FIGS. 6 and 7, it is shown that a resonance frequency is changed depending on the strength of an external magnetic field. The resonance frequency increases when the strength of the external magnetic field increases. The YIG 20 has a resonance frequency ωᵣ due to an external magnetic field. This is called a magnon mode. The frequency of the magnon mode may be determined by the Kittel's equation: ωᵣ²=ω_{H}=(ω_{H}+ωₘ)=γ²H(H+μ₀Mₛ) (where γ denotes a gyro constant, H denotes the strength of an external magnetic field, and μ₀Mₛ denotes saturation magnetization of YIG and is the eigenvalue of YIG). It is shown that the magnon mode has strong external magnetic field dependence.

According to an embodiment, an effective relative permeability is calculated using γ₀/2π=28 GHz/T, μ₀Mₛ=0.172T, α=3.2×10⁻⁴, and μ₀H=68.5 mT in Equation 2.

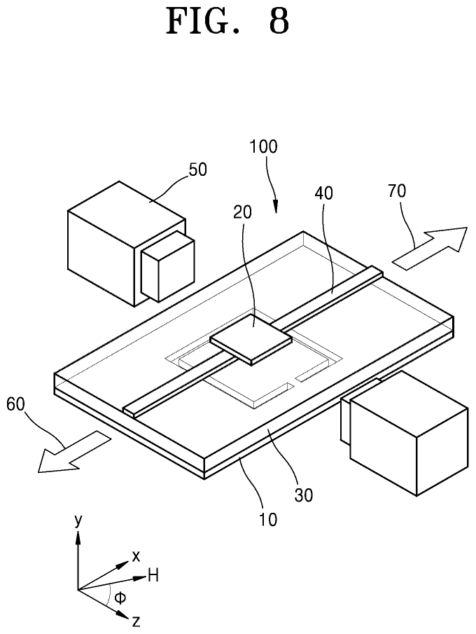

FIG. 8 is a schematic view of a photon-magnon coupling system according to an embodiment of the present invention.

A negative refractive index may be basically achieved by implementing negative values of real parts of a permittivity ε(=ε′−i·ε″) and a permeability μ(=μ′−i·μ″) in a common frequency range. This is called a double-negative (DNG) material. Although single-negative (SNG) materials with a negative permittivity and a positive permeability or with a positive permittivity and a negative permeability have been studied a lot, implementation of DNG materials is still not easy. However, because the condition of ε′<0 and μ′<0 is not always required for a negative refractive index, a more generalized condition of ε′·μ″+ε″·u′<0 for negative refractive index media may be adopted. This may also be implemented in SNG materials.

Because the negative refractive index materials reported so far have a specific structure once produced, operating frequency ranges and functions thereof may not be easily controlled with external control parameters. Although flexible controllability of negative refractive index materials is required, a simplified two-dimensional (2D) structure for negative refractive index materials with broadband frequency tunability and on-off switching function still remains a challenge in terms of implementation in electromagnetic devices.

Therefore, a photon-magnon coupling system 100 according to an embodiment of the present invention uses a new physical phenomenon called photon-magnon coupling by hybridizing photon and magnon modes. Because the photon-magnon coupling system 100 shares new photonic and magnonic characteristics through strong mutual coupling, a permittivity and a permeability may be controlled in a simple planar structure by using photon-magnon coupling.

Referring to FIG. 8, the photon-magnon hybrid system 100 may include the ISRR 10 for exciting a photon mode, and the YIG layer 20 for exciting a magnon mode. Although a natural magnetic material such as ferrite may be used instead of YIG, YIG with a low damping constant a may be considered preferable.

The ISRR layer 10 with a patterned split ring may be disposed under the dielectric layer 30 to serve as a ground plane. The microstrip line 40 is provided on the dielectric layer 30. The YIG layer 20 may be disposed on the microstrip line 40. The ISRR 10 and the YIG layer 20 may be disposed to overlap each other when viewed from above.

The present invention focuses on photon-magnon coupling between the photon mode of the ISRR 10 and the magnon mode of the YIG layer 20 of the photon-magnon hybrid system 100, and external static magnetic field dependence thereof. The ISRR 10 of the photon-magnon hybrid system 100 has a change in permittivity at a resonance frequency, and the resonance frequency depends only on the size and shape and is not changed by an external static magnetic field. Meanwhile, the YIG layer 20 has a change in permeability at a resonance frequency, and the resonance frequency is changed depending on the strength of the external static magnetic field.

When the photon-magnon hybrid system 100 is configured as in FIG. 8, photon-magnon coupling occurs when the resonance frequencies of the ISRR 10 and the YIG layer 20 are matched by adjusting the strength of the static magnetic field. This is a phenomenon in which electromagnetic waves of the ISRR 10 and the YIG 20 interact with each other to exchange energy. A microwave AC current flowing along the microstrip line 40 is applied to excite and detect a dynamic mode of the YIG layer 20 coupled with an electrodynamic photon mode of the ISRR 10. An input and an output of the microstrip line 40 are connected to a calibrated 2-port VNA 60 and 70 through microwave connectors. A direct current (DC) bias magnetic field H generated by high-precision variable electromagnets 50 may be applied to the entire photon-magnon hybrid system 100 at room temperature.

As the external static magnetic field is changed, a complex permittivity and a complex permeability of the entire photon-magnon hybrid system 100 may be changed simultaneously. As such, a refractive index value is changed depending on the strength of the external static magnetic field. Particularly, negative refraction occurs at a frequency where photon-magnon coupling occurs and under a specific external static magnetic field. Therefore, a significant difference from existing technology may occur in that active control of refractive index value and operating frequency, which is not implementable with existing metamaterials, is enabled and in that a simple production method for simply overlapping an inverted split-ring and a YIG layer is used.

According to an embodiment, a width of the microstrip line 40 may be determined by calculating a total impedance to satisfy 50 Ω. When a lengthwise direction of the microstrip line 40 is the x-axis, a widthwise direction of the microstrip line 40 is the z-axis, and a direction perpendicular to the surface of the microstrip line 40 is the y-axis, a direction of the external static magnetic field may be controlled to form about 33° (a critical angle φ_{c}=33°) from the z-axis. This is to match frequencies of several magnon modes excited by the external static magnetic field to a single frequency. Frequencies of all spin wave modes excited at the critical angle may be the same as the FMR frequency. To extract only S parameters of the photon-magnon hybrid system 100, a background signal of an empty microstrip line may be subtracted from a total signal measured from the entire sample.

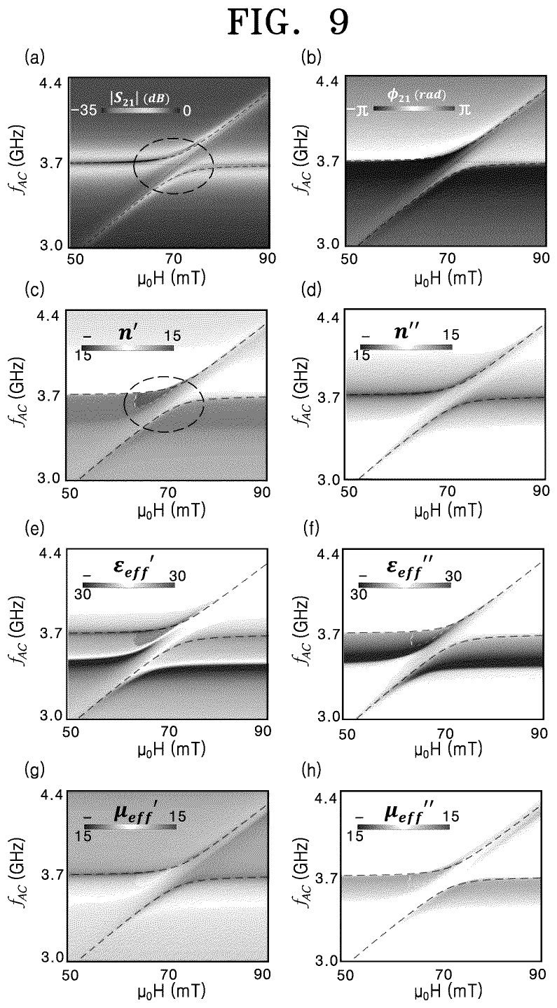

FIG. 9 includes graphs showing (a) an S₂₁ parameter amplitude, (b) an S₂₁ parameter phase, (c) and (d) real and imaginary parts of a refractive index, (e) and (f) real and imaginary parts of an effective relative permittivity, and (g) and (h) real and imaginary parts of an effective relative permeability of ISRR/YIG coupling measured through a VNA, according to an embodiment of the present invention.

Referring to (a) and (b) of FIG. 9, a size |S₂₁| and a phase φ₂₁ of an S₂₁ parameter measured using a function f(=ω/2π) are shown. A resonance frequency inside the ISRR-YIG hybrid sample is exhibited as absorption in the size |S₂₁| of the S₂₁ parameter, and it is shown that a dark part indicates a resonance mode. The |S₂₁| spectrum shows two separate split mode branches (high frequency vs low frequency) due to strong photon-magnon coupling between a photon mode of ISRR and a magnon mode (or FMR mode) of YIG. An anti-crossing phenomenon [see a dotted circle in (a) of FIG. 9] in which the two modes are shown to repel each other occurs in a resonance frequency region, and this is called photon-magnon coupling.

A complex permittivity, a complex permeability, and a refractive index value of the ISRR-YIG hybrid may be obtained based on a transmission matrix for connecting an electric field/magnetic field of the hybrid system in the measured S parameter spectrum. Because ε_{eff}=n/z and μ_{eff}=n·z are given, n may be finally obtained in terms of measurable parameters of S21 and S11 by using a refractive index n and a normalized effective impedance z of the sample.

$$n = {n}^{′} - i \cdot {n}^{″} = \sqrt{{ε}_{eff} {μ}_{eff}} = \frac{1}{{ik}_{0} {l}_{s}} ln P \\ with \\ P = \frac{{S}_{11} + {S}_{21} - Γ}{1 - ( {S}_{11} + {S}_{21} ) Γ} , Γ = ( z - 1 ) / ( z + 1 ) , and z = \pm \sqrt{\frac{{( 1 + {S}_{11} )}^{2} - {( {S}_{21} )}^{2}}{{( 1 - {S}_{11} )}^{2} - {( {S}_{21} )}^{2}}} \qquad ( Equation 3 )$$

(where Γ denotes a reflection coefficient at an interface between the ISRR-YIG hybrid and the empty microstrip line, P denotes a time-independent wave function of microwaves propagated from the ISRR-YIG hybrid, lₛ denotes a sample length, and k₀=ω/c₀ denotes a wavenumber of electromagnetic waves in vacuum (at a speed of light c₀).)

Real and imaginary parts of n, ε_{eff}, and μ_{eff} are calculated as shown in (c) to (h) of FIG. 9 from the S parameters measured using Equation 3. It is shown that the refractive index is changed depending on the external magnetic field. Particularly, it is shown that a region where photon-magnon coupling occurs [see a dotted circle in (c) of FIG. 9] has negative refraction. Particularly, negative refraction occurs at a high-frequency part among two separate split mode branches (high frequency vs low frequency). In other words, negative refraction occurs at an upper part of an anti-crossing region [see a part where n′ is negative in a dotted circle of (c) of FIG. 9]. The real part n′ of the refractive index n may have a larger negative value when the strength of photon-magnon coupling increases.

Meanwhile, according to an embodiment, the strength of photon-magnon coupling may be changed depending on a relative position between a first layer [or the ISRR 10] for exciting a photon mode and a second layer [or the YIG layer 20] for exciting a magnon mode. According to an embodiment, the strength of photon-magnon coupling may be changed depending on the shape of an ISRR of the first layer. According to an embodiment, the strength of photon-magnon coupling may be changed depending on the type, shape, size, or the like of a magnetic material of the second layer. According to an embodiment, the second layer for exciting the magnon mode may be a magnetic multilayer film including a ferromagnet, a ferrimagnet, an antiferromagnet, or the like. According to an embodiment, the dielectric layer 30 including a magnetic film or a magnetic multilayer film, or a combination of the dielectric layer 30 and a magnetic film pattered on the dielectric layer 30 may be used as the second layer for exciting the magnon mode.

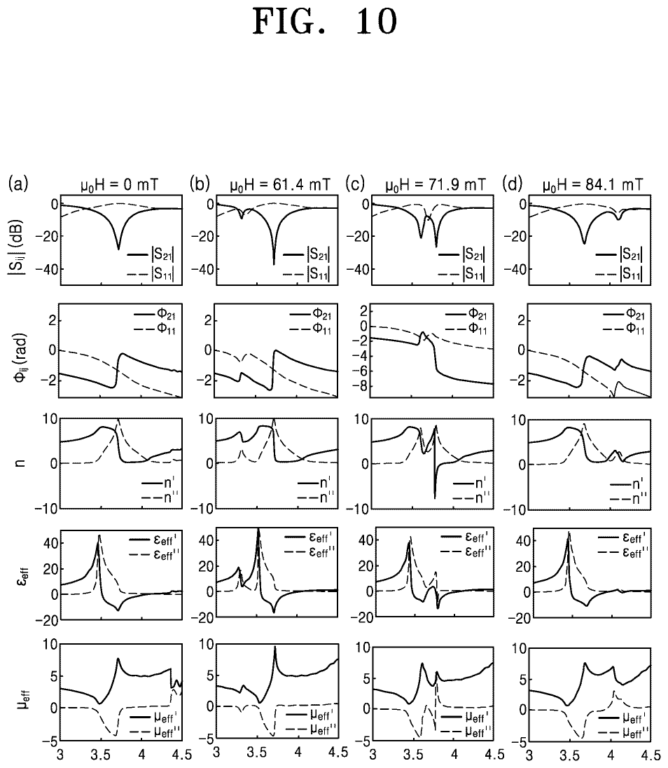

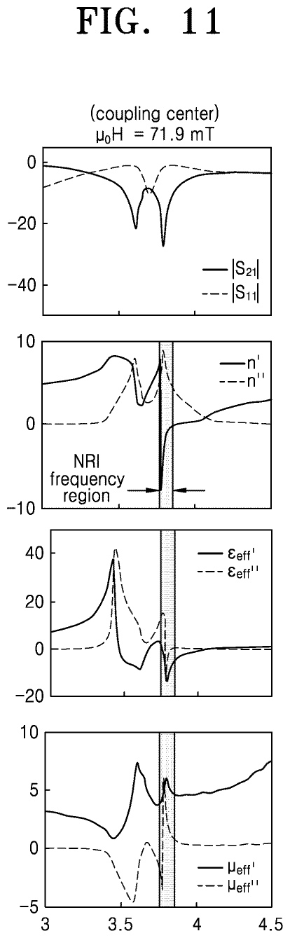

FIG. 10 includes graphs showing |Sᵢⱼ|, a retrieved refractive index, an effective relative permittivity, and an effective relative permeability of ISRR/YIG coupling measured through a VNA at (a) μ₀H=0, (b) μ₀H=61.4 mT, (c) a coupling center μ₀H=71.9 mT, and (d) μ₀H=84.1 mT, according to an embodiment of the present invention. FIG. 11 includes graphs showing |Sᵢⱼ|, a retrieved refractive index, an effective relative permittivity, and an effective relative permeability of ISRR/YIG coupling measured through a VNA at a coupling center μ₀H=71.9 mT, according to an embodiment of the present invention.

At each bias field strength, |Sᵢⱼ| and ε_{eff} exhibit common resonance characteristics similar to those of a general electric dipole based on the Drude model. However, μ_{eff} exhibits a behavior opposite to that of a general magnetic dipole. Referring to the fifth graph in (a) of FIG. 10, it is shown that negative absorption of μ_{eff}′ and μ_{eff}′ with opposite vibration shapes is exhibited at a resonance frequency (ω/2π=3.71 GHz). This is because of phase shift of a time-independent wave function P of microwaves propagated from the ISRR-YIG hybrid, which is caused by a sample length lₛ.

It is shown that, near the resonance frequency, the ISRR-YIG hybrid system 100 has ε_{eff}′<0, ε_{eff}′>0, μ_{eff}′>0, and μ_{eff}′>0(≈0). Particularly, μ_{eff}′>0 may be exhibited because a volume fraction of the YIG layer 20 in the entire system 100 is small. While a flat background of the S11spectrum at μ₀H=0 becomes a small single dip due to magnon excitation by the YIG layer, the single dip of the |S₂₁| spectrum at μ₀H=0 is split into double dips as the magnetic field approaches 71.9 mT. When μ₀H=71.9 mT, |S₂₁| shows the most evident mode splitting due to the strongest photon-magnon coupling [see (c) of FIG. 10].

Imaginary parts ε_{eff}″ and μ_{eff}″ of permittivity and permeability are loss terms and represent energy loss or attenuation of a dielectric/magnetic material. Although an existing pure ISRR [see FIGS. 1 to 4] has ε_{eff}″>0 and μ_{eff}″<0, the ISRR-YIG hybrid has ε_{eff}″<0 and μ_{eff}″>0 due to strong coupling in the anti-crossing region, thereby switching the signs of the imaginary parts. This is because ISRR and YIG exchange energy due to photon-magnon coupling to cause a phenomenon in which a loss becomes a gain and a gain becomes a loss, and a negative refractive index may be obtained by satisfying a condition of ε_{eff}′·μ_{eff}″+ε_{eff}″·μ_{eff}′<0.

Particularly, it is noteworthy that, in the anti-crossing region, n′ is changed to a negative value near a frequency slightly higher than the resonance frequency of the ISRR [see (c) of FIG. 10 and the second graph of FIG. 11]. According to (c) of FIG. 10 and FIG. 11, due to strong coupling (between the excited magnon mode of the YIG layer and the photon mode of the ISRR), a decrease in μ_{eff}′ and an increase in μ_{eff}″ with a positive sign may satisfy the condition of ε_{eff}′·μ_{eff}″+ε_{eff}″·μ_{eff}′<0 and a negative refractive index may be obtained. As the magnetic field additionally increases, the refractive index at ω/2π≈3.71 GHz approaches μ₀H=0 due to an increase in μ_{eff}′ and a decrease in μ_{eff}″ as shown in (d) of FIG. 10. FIG. 10 clearly shows that not only the real parts but also the imaginary parts of ε_{eff} and μ_{eff} mainly contribute to the negative refractive index of the ISRR-YIG hybrid to make it a SNG (ε-negative) material. The imaginary part (or loss term) turns out to be one of the most significant key parameters not only for the photon-magnon coupling phenomenon but also for the negative refractive index mediated by photon-magnon coupling.

Referring back to FIGS. 10 and 11, it is shown that, unlike existing meta structures, the negative refractive index based on photon-magnon coupling is controllable in a relatively wide frequency band by a bias magnetic field applied from outside. The frequency band required for the negative refractive index is wide, 380 MHz (3.41 to 3.89 GHz), at a relatively low magnetic field of μ₀H=63.3 to 78.4 mT. That is, a negative refractive index value and an operating frequency based on photon-magnon coupling may be adjusted by the strength and frequency of the external magnetic field.

The negative refractive index controllable by the magnetic field may provide on-off switching. According to an embodiment, the on-off switching of the negative refractive index may be provided based on whether the condition of ε_{eff}′·μ_{eff}″+ε_{eff}″μ_{eff}′<0 is satisfied by controlling the strength and frequency of the external magnetic field. According to an embodiment, the ISRR-YIG hybrid system 100 is implemented with a small and simple design in a planar shape of only 5 mm ×2 cm as a result of strong coupling between a photon mode of an ISRR and a magnon mode of YIG. In addition, due to the planar structure of the ISRR-YIG hybrid and easy positioning of a microwave field, excitation of a higher-order spin wave mode in which photons of the ISRR may be coupled may be allowed to tune a resonance frequency of negative refraction. The above mechanism and tunability for achieving the negative refractive index are fundamentally different from the approaches in the field of existing metamaterials.

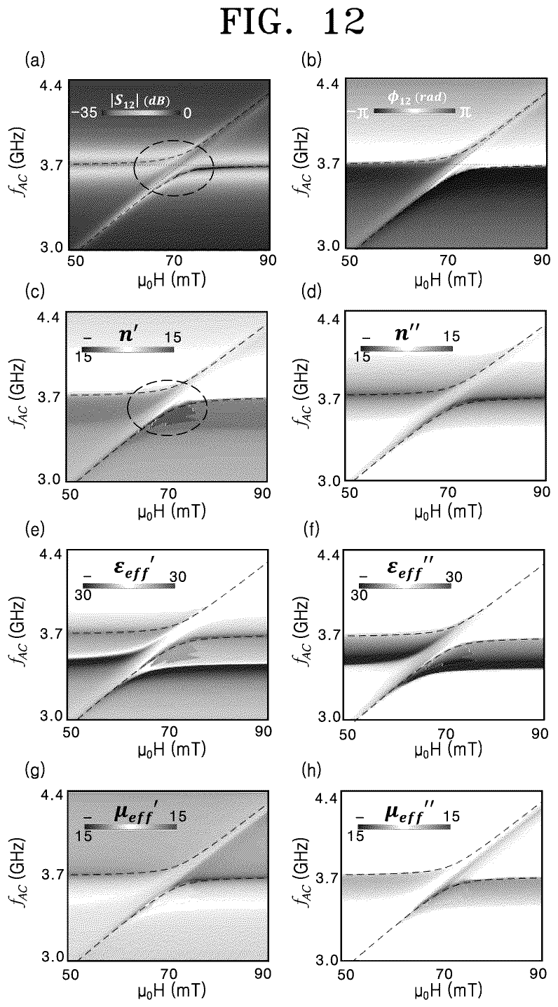

FIG. 12 includes graphs showing (a) an S₁₂ parameter amplitude, (b) an S₁₂ parameter phase, (c) and (d) real and imaginary parts of a refractive index, (e) and (f) real and imaginary parts of an effective relative permittivity, and (g) and (h) real and imaginary parts of an effective relative permeability of ISRR/YIG coupling measured through a VNA, according to an embodiment of the present invention.

FIG. 12 includes graphs for S₁₂ (Port2→Port1) when electromagnetic waves flow in a reverse direction of S₂₁ (Port1→Port2) [see FIG. 9]. Although a negative refractive index of S₂₁ is exhibited at an upper part of an anti-crossing region in (a) and (c) of FIG. 9, a negative refractive index of S₁₂ is exhibited at a lower part of the anti-crossing region in FIG. 12. This means that the negative refractive index flows in one direction. As such, the photon-magnon hybrid system 100 of the present invention may adjust not only the negative refractive index but also the direction of the negative refractive index by using a magnetic field.

Particularly, negative refraction occurs at a low-frequency part among two separate split mode branches (high frequency vs low frequency). In other words, negative refraction occurs at an upper part of an anti-crossing region [see a part where n′ is negative in a dotted circle of (c) of FIG. 12].

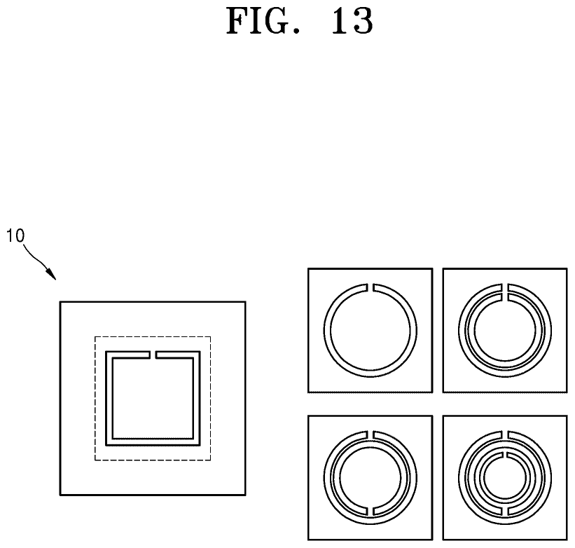

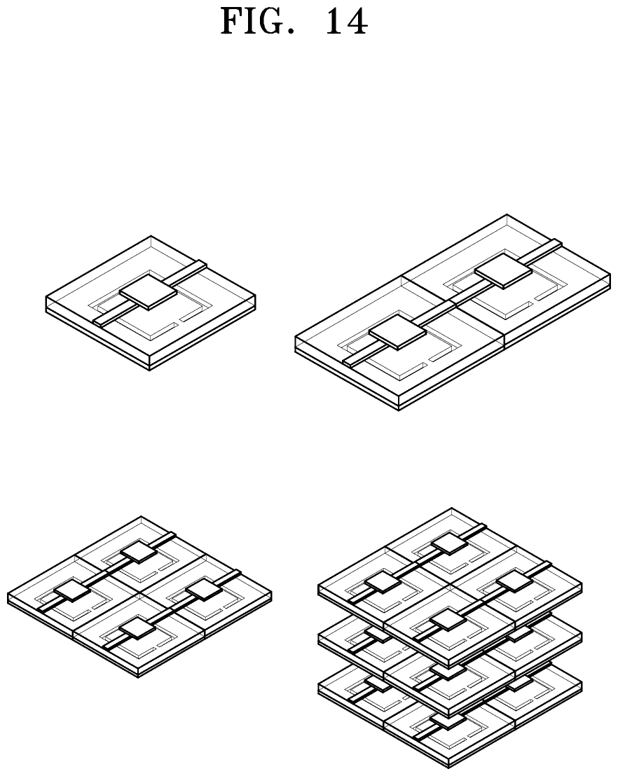

FIG. 13 is a schematic view showing various ISRR shapes according to embodiments of the present invention. FIG. 14 is a schematic view showing various photon-magnon coupling system arrangements, according to embodiments of the present invention.

The ISRR 10 of the present invention may have various pattern shapes. Referring to FIG. 13, an angular pattern or a curved pattern, e.g., a circular and oval pattern, may be provided and one or more split rings may be formed. In addition to the ISRR 10, a split-ring resonator (SRR) may also be used as long as it may excite a photon mode and enable coupling with a magnon mode of the YIG layer 20.

Referring to FIG. 14, one or more photon-magnon coupling systems 100 may be arranged. Not only 1-dimensional and 2-dimensional arrangements but also 3-dimensional arrangements are allowed.

As described above, unlike existing metamaterial-based devices, a device using photon-magnon coupling, according to an embodiment of the present invention, enables easy production and active control of properties and thus may be applied to various industries such as communication antennas, radars, measuring instruments, and electronic application devices.

While the present invention has been particularly shown and described with reference to embodiments thereof, it will be understood by one of ordinary skill in the art that various changes in form and details may be made therein without departing from the scope of the present invention as defined by the following claims.

1. A method of implementing negative refraction based on photon-magnon coupling using a photon-magnon hybrid system,
wherein the photon-magnon hybrid system comprises:
a dielectric layer comprising a first surface, and a second surface opposite to the first surface;
a microstrip line disposed on the first surface and extending along a lengthwise direction;
a first layer disposed on the second surface to excite a photon mode; and
a second layer disposed on the microstrip line to excite a magnon mode, and
wherein a negative refractive index signal is obtained due to photon-magnon coupling between the first and second layers.

2. The method of claim 1, wherein the first layer comprises an inverted split-ring resonator (ISRR).

3. The method of claim 2, wherein the first layer serves as a ground plane.

4. The method of claim 1, wherein the first layer comprises an inductance part and a capacitance part, and has a resonance frequency.

5. The method of claim 1, wherein the first layer has a photon mode in which a resonance frequency is constant regardless of a strength of an external magnetic field.

6. The method of claim 1, wherein the second layer comprises yttrium iron garnet (YIG).

7. The method of claim 1, wherein the second layer has a magnon mode in which a resonance frequency increases when a strength of an external magnetic field increases.

8. The method of claim 1, wherein, when a permittivity and a magnetic permeability of the photon-magnon hybrid system are given as ε=ε′−i·ε″ and μ=μ′−i·μ″, respectively, ε′·μ″+ε″··′ <0 is satisfied.

9. The method of claim 1, wherein the photon-magnon coupling occurs when resonance frequencies the first and second layers are matched by adjusting a strength of an applied magnetic field.

10. The method of claim 1, wherein, due to the photon-magnon coupling, the photon and magnon modes exhibit an anti-crossing phenomenon in an |S₂₁| or |S₁₂| spectrum corresponding to a resonance frequency region.

11. The method of claim 10, wherein, in the |S₂₁| spectrum, a negative refractive index signal is exhibited at a high-frequency part in an anti-crossing region split into high-frequency and low-frequency parts.

12. The method of claim 10, wherein, in the |S₁₂| spectrum, a negative refractive index signal is exhibited at a low-frequency part in an anti-crossing region split into high-frequency and low-frequency parts.

13. The method of claim 1, wherein the |S₂₁| spectrum exhibits evident mode splitting when the photon-magnon coupling is strong.

14. The method of claim 10, wherein, in the |S₂₁| spectrum, a real part n′ of a refractive index n is changed to a negative value at a frequency at least higher than a resonance frequency of the first layer, in a anti-crossing region.

15. The method of claim 10, wherein, in the |S₁₂| spectrum, a real part n′ of a refractive index n is changed to a negative value at a frequency at least lower than a resonance frequency of the first layer, in a anti-crossing region.

16. The method of claim 11, wherein a frequency band where the negative refractive index signal is exhibited is wider than 380 MHz.

17. The method of claim 8, wherein at least one of a strength and a frequency of an applied magnetic field is adjusted to satisfy ε′·μ″+ε″·μ′<0, and
wherein a negative refractive index is switched on when ε′·μ″+ε″·μ′<0 is satisfied, or off when ε′·μ″+ε″·μ′<0 is not satisfied.

18. A method of implementing negative refraction based on photon-magnon coupling using a photon-magnon hybrid system,
wherein the photon-magnon hybrid system comprises a first part for exciting a photon mode, and a second part for exciting a magnon mode, and
wherein a negative refractive index signal is obtained due to photon-magnon coupling between the first and second parts.

19. The method of claim 18, wherein, when a permittivity and a magnetic permeability of the photon-magnon hybrid system are given as ε=ε′−i·ε″ and μ=μ′−i·μ″, respectively, the negative refractive index signal is obtained by adjusting at least one of a strength and a frequency of an applied magnetic field to satisfy ε′·μ″+ε″·μ′<0.

20. A method of controlling negative refraction based on photon-magnon coupling using a photon-magnon hybrid system,
wherein the photon-magnon hybrid system comprises:
a dielectric layer comprising a first surface, and a second surface opposite to the first surface;
a microstrip line disposed on the first surface and extending along a lengthwise direction;
a first layer disposed on the second surface to excite a photon mode; and
a second layer disposed on the microstrip line to excite a magnon mode,
wherein a negative refractive index signal is obtained due to photon-magnon coupling between the first and second layers, and
wherein, when a permittivity and a magnetic permeability of the photon-magnon hybrid system are given as ε=ε′−i·ε″ and μ=μ′−i·μ″, respectively, at least one of a strength and a frequency of an applied magnetic field is adjusted to satisfy ε′·μ″+ε″·μ′<0.
